(19) United States
(12) Patent Application Publication
(10) Pub. No.: US 2017/0343453 A1
(43) Pub. Date: Nov. 30, 2017

(54) APPARATUS FOR HOLDING A TIRE IN A TIRE BALANCING MACHINE

(71) Applicant: Akron Special Machinery, Inc., Akron, OH (US)

(72) Inventors: Joseph A. FARELLI, Berlin City, OH (US); Michael C. HAINES, Wadsworth, OH (US); Alexander Josef Werner HASBACH, Akron, OH (US)

(21) Appl. No.: 15/166,456

(22) Filed: May 27, 2016

(51) Int. Cl. G01M 17/02

(52) U.S. Cl. CPC G01M 17/021

(57) ABSTRACT

An apparatus (10) for holding a tire in a tire balancing machine includes a base (12) that receives a locking member (14). When locking member (14) is positioned in base (12), a tire is secured between an upper rim (16) and a lower rim (18). Base (12) includes an inner sleeve (20) carrying ball bearings (22) in channels (28) therein. An outer sleeve (30) is positioned around inner sleeve (20) and is moveable between an unlocked position and a locked position. Outer sleeve (30) urges movement of the ball bearings (22) through the channels (28) in the inner sleeve (20), to particularly allow movement of inner ball bearings (22A) into and out of receptive grooves (78) in the outer surface of a locking base (66) of the locking member (14).

### TECHNICAL FIELD

The present invention relates to an apparatus for holding a tire in a tire balancing machine. In particular, the present invention is directed an apparatus for holding a tire utilizing a ball bearing locking mechanism.

### BACKGROUND

Manufactured tires generally undergo certain testing before being made available for sale to the public. One such test includes checking the balance of a tire by rotating the tire at a high speed. The machines used for testing the balance of a tire must secure the tire in position, while also maintaining the ability to rotate the tire.

One prior device, shown in U.S. Pat. No. 6,131,455, includes a lock shaft 300 that is placed in a bracket 150 in order to secure a testing tire T between a lower rim 10 and an upper rim 20. Lock shaft 300 is secured in place by lock members 160 that are driven by air-supplied locking cylinders 165.

However, there remains a need in the art for an improved apparatus for holding a tire in a tire balancing machine. More particularly, there remains a need in the art for an improved locking mechanism.

### SUMMARY OF THE INVENTION

It is thus an object of one aspect of the present invention to provide an improved apparatus for holding a tire in a tire balancing machine. It is an object of another aspect of the invention to provide an apparatus, as above, in which a locking member is positionable in a base.

It is an object of a further aspect of the present invention to provide an apparatus, as above, in which the locking member includes a locking shaft having receptive grooves in the outer surface thereof, one or more of the receptive grooves receiving a plurality of inner ball bearings when the locking member is in a downward, locking position.

It is an object of an additional aspect of the present invention to provide an apparatus, as above, in which an inner sleeve includes channels therethrough, the channels housing ball bearings therein, the inner sleeve being positioned inwardly of an outer sleeve, where movement of the outer sleeve places the ball bearings in a locked position.

These and other objects of the present invention, as well as the advantages thereof over existing prior art forms, which will become apparent from the description to follow, are accomplished by the improvements hereinafter described and claimed.

In general, an apparatus for holding a tire in a tire balancing machine includes a sleeve having a plurality of ball bearings therein. A locking member having an outer surface with a groove therein is positionable in the sleeve. The groove of the locking member receives a ball bearing from each of the channels when the locking member is positioned in the sleeve.

The present invention also includes a method of securing a tire to be tested for balancing which includes the steps of placing a first side of a tire on a first rim carried by a sleeve. A locking member which carries a second rim is moved to a position within the sleeve. After the second rim engages the second side of the tire, the locking member is locked to the sleeve.

A preferred exemplary apparatus for holding a tire in a tire balancing machine is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a vertical section through one component of the tire locking apparatus in accordance with the concepts of the present invention.

FIG. 2 is a vertical section of the locking member thereof.

FIG. 3 is a vertical section of the base thereof.

FIG. 4 is an enlarged view of the ball bearing lock mechanism thereof.

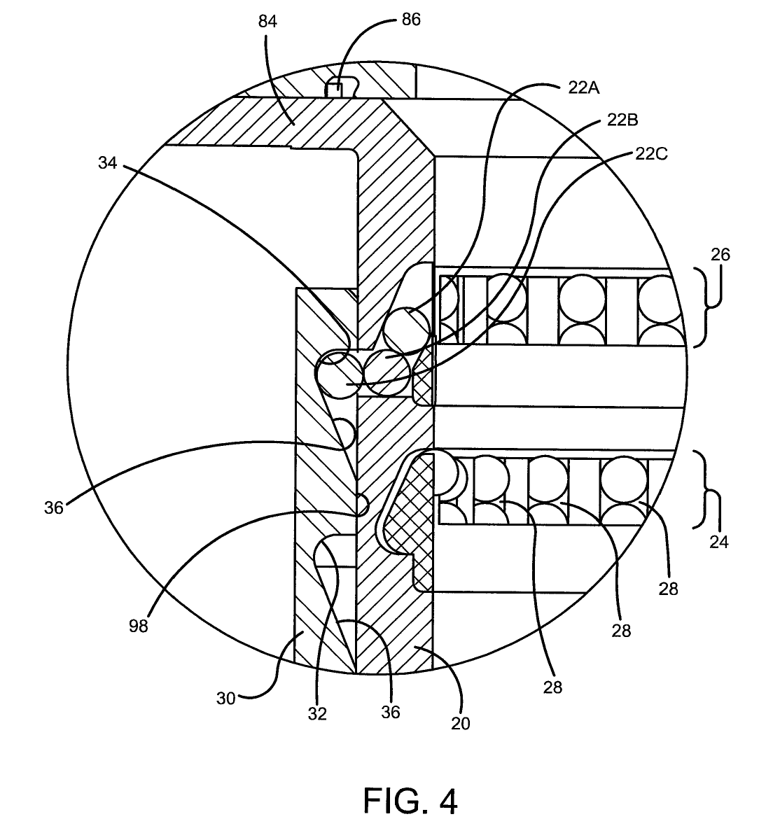

### PREFERRED EMBODIMENT FOR CARRYING OUT THE INVENTION

An apparatus for checking the balance of a tire is generally indicated by the numeral 10 and includes a base, generally indicated by the numeral 12, which receives a locking member, generally indicated by the numeral 14, positioned therein. When locking member 14 is positioned in base 12, a tire (not shown) to be tested is secured between an upper tire rim 16 and a lower tire rim 18. Lower rim 18 can also be described as a stationary tire rim 18 and upper rim 16 can also be described as a moveable tire rim 16.

Base 12 includes a cylindrically shaped inner sleeve 20 having a bore therethrough. Inner sleeve 20 is adapted to receive at least a portion of locking member 14 as will be hereinafter described. Inner sleeve 20 carries at least one row of ball bearings 22. For example, inner sleeve 20 can include a first row 24 of ball bearings 22 and a second row 26 of ball bearings 22. Second row 26 is longitudinally spaced from said second row 24.

Each row 24, 26 of ball bearings 22 includes a plurality of channels 28 for receiving ball bearings 22. Channels 28 are circumferentially spaced about each row 24, 26 and extend through the sidewall of inner sleeve 20. In one or more embodiments, each channel 28 includes three ball bearings 22. Thus, in these embodiments, each channel 28 includes an inner ball bearing 22A, a middle ball bearing 22B, and an outer ball bearing 22C. The movement of ball bearings 22 enacts a locking function as will be hereinafter described.

In one or more embodiments, each row 24, 26 of ball bearings 22 includes sixteen channels 28 of ball bearings 22. Thus, in these embodiments, each channel 28 will be approximately spaced 22.5° from the next nearest channel 28, where the 22.5° is with reference to the circular cross-section of inner sleeve 20.

The numbers of rows, channels, and ball bearings utilized can be determined based on the force or load required by apparatus 10 for properly securing and checking the balance of a tire. In one or more embodiments, the numbers of rows, channels, and ball bearings are selected such that apparatus 10 is suitable for the largest load required by apparatus 10. That is, the numbers of rows, channels, and ball bearings utilized will generally allow for a range of tires to be tested, each tire requiring apparatus 10 to possess a sufficient, predetermined load in order to properly secure and check the balance of the tire.

Channels 28 can also be characterized by the angle, or slope, of the channels 28 themselves. In certain embodiments, the angle of channels 28 is 22°, or approximate thereto, where the 22° is with reference to the vertical axis. The angle of channels 28 allows movement of ball bearings 22 therein as will be hereinafter described.

Base 12 further includes a cylindrically shaped outer sleeve 30 proximately positioned around inner sleeve 20. Outer sleeve 30 includes a bore therethrough, with inner sleeve 20 being positioned in the bore. Outer sleeve 30 is movable between an upper position and a lower position to enact a locking function, as will be hereinafter described. Outer sleeve 30 includes at least one receptive groove therein for receiving corresponding ball bearings 22. For example, outer sleeve 30 can include a first receptive groove 32 for receiving the ball bearings 22 from the second row 24, and a second receptive groove 34 for receiving the ball bearings 22 from the second row 26. Preferably, outer sleeve 30 includes the same number of receptive grooves as rows of ball bearings in inner sleeve 20. Each receptive groove 32, 34 is formed into the sidewall of outer sleeve 30 and includes a sloped circumferential surface 36, the function of which will be hereinafter discussed.

Outer sleeve 30 is coupled to a circular guide plate 38 so that it may be moved between an upper position and a lower position. For example, one or more extending rods 40 can be used to couple guide plate 38 to outer sleeve 30. Extending rods 40 can be received in a hole or channel (not shown) in outer sleeve 30. Then, a fastener 42 can be used to secure guide plate 38 in a fixed position with respect to outer sleeve 30. Thus, when guide plate 38 is urged upward or downward, as will be hereinafter described, outer sleeve 30 will move correspondingly.

To enact upward and downward movement, guide plate 38 is positioned between two sets of upper guide members 44 and lower guide members 46. That is, each upper guide member 44 is positioned longitudinally upward from the upper surface of guide plate 38 and each lower guide member 46 is positioned longitudinally downward from the lower surface of guide plate 38. Upper guide members 44 and lower guide members 46 are respectively proximately positioned to guide plate 38 so as to cause movement thereof. Each guide member includes a base portion 48 extending from a plate support portion 50, the base portion being secured to a base 52. Plate support portions 50 can be cylindrically shaped, and as previously described, a portion of guide plate 38 is positioned between each set of plate support portions 50 such that movement of plate support portions 50 urges movement of guide plate 38.

Each set of upper guide members 44 and lower guide members 46 is coupled to an air cylinder 54 to cause upward and downward movement thereof. For example, air cylinder 54 is shown as being longitudinally coupled to base 52, with upper guide members 44 and lower guide members 46 being latitudinally coupled to base 52. Thus, air cylinders 54 can be actuated to move base 52 upward and downward, thereby moving upper guide members 44 and lower guide members 46, thereby moving guide plate 38, and thereby moving outer sleeve 30. This movement allows apparatus 10 to enact a locking function as will be hereinafter described.

Outer sleeve 30 can also include one or more gas springs 55 affixed thereto. Such gas springs 55 are generally known to one skilled in the art and could be utilized to exert an additional force for moving outer sleeve 30 upward, over and above the force being applied by air cylinders 54. For example, the piston of gas spring 55 could be coupled to outer sleeve 30, with the cylinder of gas spring 55 coupled to a plate 56 coupled to inner sleeve 20. Thus, gas spring 55 could be actuated to provide additional force for moving outer sleeve 30 upward.

In addition to the upward and downward movement of outer sleeve 30 being restricted by the travel distance of air cylinders 54, the circular plate 56 is also present to restrict downward travel of outer sleeve 30. As previously stated, plate 56 is coupled to inner sleeve 20. For example, plate 56 can be secured to inner sleeve 20 by providing a fastener 58 in a threaded channel 60 in inner sleeve 20. Thus, the fixed position of plate 56 with respect to inner sleeve 20 restricts the downward travel of outer sleeve 30. Plate 56 includes holes therethrough so as to allow rods 40 to be positioned therein.

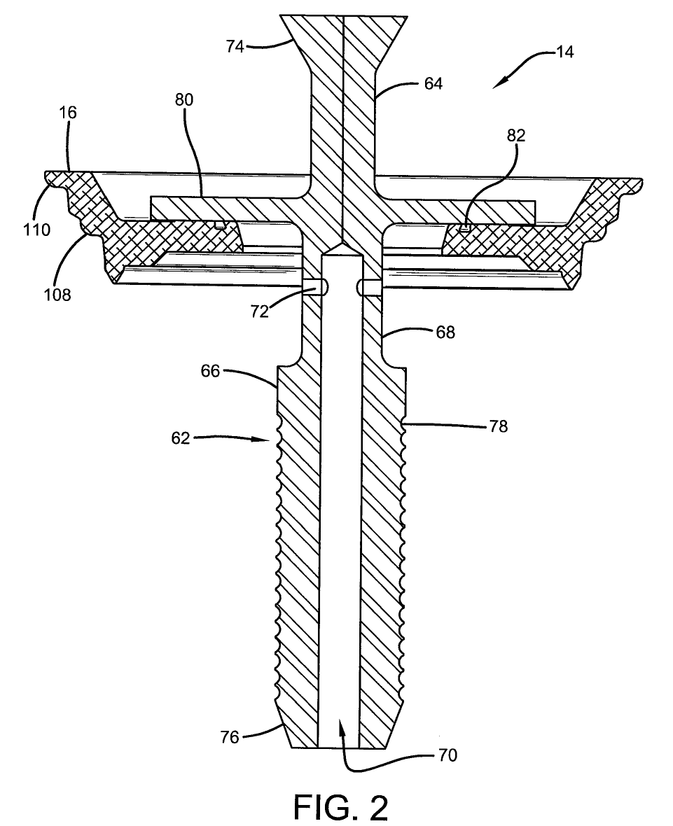

As previously described, apparatus 10 further includes a locking member 14, as best shown in FIG. 2, positionable in base 12. More specifically, at least a portion of a locking shaft, generally indicated by the numeral 62, of locking member 14 is positionable in inner sleeve 20. Locking shaft 62 includes a longitudinally extending handle portion 64 at one end and an enlarged locking base 66 at the other end. Between handle portion 64 and locking base 66, shaft 62 includes a portion for supplying air to inflate a tire to be tested, which can be described as an air supply portion 68.

Air supply portion 68 is located at an end of a partial bore, generally indicated by the numeral 70. Partial bore 70 extends through base 66 and into air supply portion 68. To supply air to inflate a tire to be tested, air is provided through partial bore 70 and into an air passageway 72. Air passageway 72 communicates with the interior of a tire to be tested when the tire is in place as to inflate the tire.

As seen in FIG. 2, each end of locking member 14 can be tapered. The end of locking member 14 nearest handle portion 64 can include an outward taper 74. Outward taper 74 can be particularly useful for allowing locking member 14 to be grabbed by another apparatus and located in the proper position. The end of locking member 14 nearest locking base 66 can include an inward taper 76. Inward taper 76 can be particularly useful for allowing locking member 14 to be more easily positioned in inner sleeve 20.

Locking base 66 has an outer surface formed with a plurality of receptive grooves 78 for receiving ball bearings 22. In one or more embodiments, receptive grooves 78 span the entire outer surface of locking base 66. Based on the plurality of receptive grooves 78, it should be appreciated that different sized tires, such as tires of various widths, can be utilized with apparatus 10 as will be hereinafter described.

Handle portion 64 includes a circular support member 80 extending latitudinally therefrom. Cylindrical support member 80 is coupled to upper rim 16, such as by a fastener (not shown). For example, upper rim 16 can include a plurality of threaded channels therein, and cylindrical support member 80 can include a plurality of holes therethrough. The threaded channels can be adapted to align with the holes, the channels and holes being adapted to receive a fastener for securing upper rim 16 to cylindrical support member 80. Upper rim 18 is secured to cylindrical support member 80 so as to move upper rim 16 into position to secure a testing tire between upper rim 16 and lower rim 18 as will be hereinafter described. In one or more embodiments, o-ring 82 is provided between upper rim 16 and cylindrical support member 80.

Similarly, lower rim 18 is carried by a radially extending plate 84 extending from the top of inner sleeve 20. Lower rim 18 can be coupled to plate 84 such as by a fastener 81. For example, lower rim 18 can include a plurality of holes therethrough, and radially extending plate 84 can include a plurality of threaded channels therein. The threaded channels in radially extending plate 84 may also extend into sidewall 90. The threaded channels can be adapted to align with the holes, the channels and holes being adapted to receive a fastener for securing lower rim 18 to radially extending plate 84. In one or more embodiments, o-ring 86 is provided between lower rim 18 and radially extending plate 84.

Radially extending plate 84 forms a part of a spindle, generally indicated by the numeral 88. Spindle 88 includes a cylindrically shaped sidewall 90 extending from plate 84. Sidewall 90 is positioned within a spindle housing, generally indicated by the numeral 91, which can include a top radially extending member 93 secured to a cylindrically shaped sidewall 95. Cylindrically shaped sidewall 95 extends from top member 93. Top member 93 can be secured to sidewall 95 by a fastener 97. Sidewall 95 can optionally be coupled to auxiliary housing, generally indicated by the numeral 92, where auxiliary housing 92 can include platform 94 and attachment base 96. One or more components of auxiliary housing 92 can be further coupled to another component of apparatus 10, to another machine, or to a support structure.

One or more ball bearings can be positioned between sidewall 90 and sidewall 95. For example, two upper bearing sets, generally indicated by the numerals 99, 101, and one lower bearing set, generally indicated by the numeral 103 can be positioned between sidewall 90 and sidewall 95. Such ball bearings are generally known to one skilled in the art and can include an inner race 105, a plurality of balls 107, and an outer race 109.

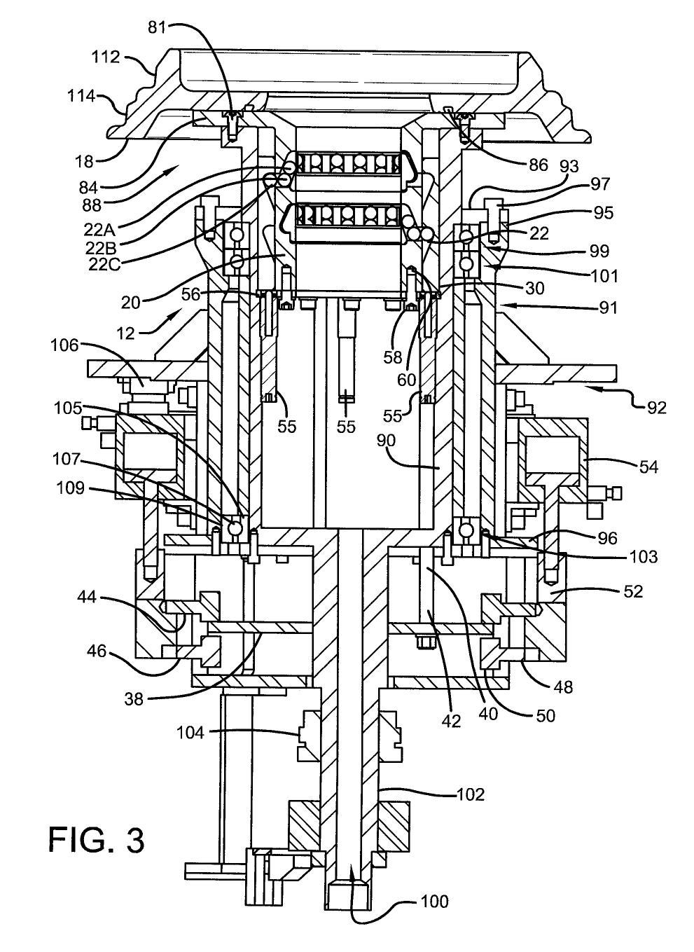

In the operation of apparatus 10, outer sleeve 30 is first positioned in base 12 in a lower position, as seen in FIG. 3, with the downward travel of outer sleeve 30 being defined by the positioning of plate 56 and the travel limit of air cylinders 54. When outer sleeve 30 is in the lower position, outer ball bearings 22C are positioned in the corresponding receptive grooves 32, 34. Middle ball bearings 22B and inner ball bearings 22A are positioned fully in channels 28 so as to not restrict the travel of locking member 14 upon insertion into inner sleeve 20.

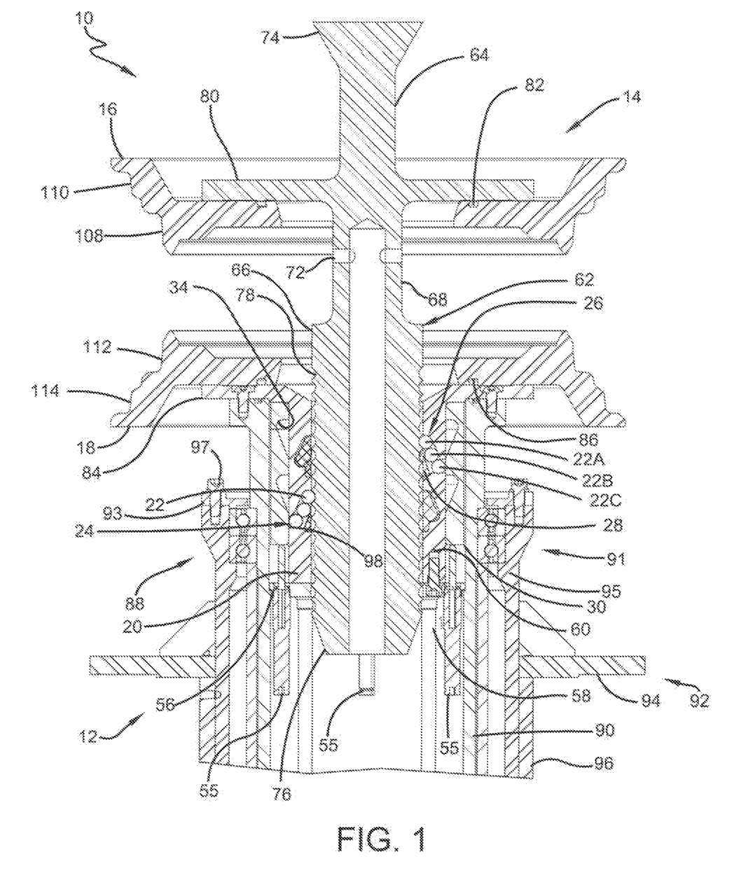

When outer sleeve 30 is positioned in the lower position, a tire to be tested (not shown) is positioned on lower rim 18. Locking base 66 of locking shaft 62 is then inserted through the tire and inner sleeve 20, as shown in FIG. 1. This also brings upper rim 16 into contact with the tire as to sandwich the tire between upper rim 16 and lower rim 18. Once locking shaft 62 is in the desired position, outer sleeve 30 is urged toward and to top frame member 84. As previously described, air cylinders 54 can then be actuated to move base 52 upward, thereby moving upper guide members 44 and lower guide members 46 upward, thereby moving guide plate 38 upward, and thereby moving outer sleeve 30 upward.

As previously described, each receptive groove 32, 34 of outer sleeve 30 includes a sloped inner circumferential surface 36. As outer sleeve 30 is urged toward and to top frame member 84, sloped circumferential surfaces 36 urge ball bearings 22 toward locking shaft 62. Sloped circumferential surfaces 36 engage outer ball bearings 22C to urge them toward locking base 66, thereby causing outer ball bearings 22C to urge movement of middle ball bearings 22B, which thereby urge movement of inner ball bearings 22A. This urges inner ball bearings 22A into a corresponding receptive groove 78 in locking base 66. When outer sleeve 30 is positioned proximate top frame member 84, bearing retainers 98 in the inner surface of outer sleeve 30 maintain ball bearings 22 such that inner ball bearing 22A maintains its position in the corresponding receptive groove 78 in locking base 66. This provides the locking function to maintain locking member 14 in a downward locked position. That is, bearing retainers 98 fixedly position ball bearings 22 such that locking member 14 is prevented from traveling until outer sleeve 30 is again moved to a lower unlocked position.

Once a tire is secured in position by the above described locking function, the dynamic balance of the tire, the static balance of the tire, or both the dynamic balance and static balance of the tire can be tested. These testing methods are generally known to those skilled in the art. In order to conduct a balance measurement, an air supply (not shown) supplies air through an air bore, generally indicated by the numeral 100, through partial bore 70, through opening 72, and into the inside of the tire to be tested. Opening 72 is formed as a bore through air supply portion 68 of locking shaft 62. Thus, the tire to be tested can be properly inflated while also being secured between the upper rim 16 and lower rim 18. The inflation of the tire provides a separation force to apparatus 10, which further urges inner ball bearings 22A into a corresponding receptive groove 78 in locking base 66, thereby providing additional locking force.

Once the tire to be tested is properly inflated, the tire can be rotated by mechanisms generally known to those skilled in the art. For example, such might include the use of one or more belts, pulleys, and motors (not shown). Such belts, pulleys, and motors can be coupled to a shaft 102 of base 12, and can be particularly coupled to an attachment location 104. This rotation of the tire to be tested can be used to detect a variation in the load effected on a load cell 106. One or more methods for determining balance of a tire based on the detected variation of a load are generally known by those skilled in the art. Where a dynamic balance is performed, these methods calculate which portion of the testing tire a balance weight is to be placed, if at all, based on the result of the calculation of dynamic balance, and a marking device (not shown) can mark the location of tire unbalance.

After a tire to be tested has been rotated and tested, the tire is deflated. Then, the air cylinders 54 are actuated to move downward, thereby moving base 52 downward, thereby moving upper guide members 44 and lower guide members 46 downward, thereby moving guide plate 38 downward, and thereby moving outer sleeve 30 downward. Also, any gas springs 55, if present, are deactuated as to allow downward travel. Outer sleeve 30 travels downward until positioned proximate to plate 56, which is the unlocked position.

In the reverse manner as the locking function, the downward travel of outer sleeve 30 causes ball bearings 22 to be urged away from locking base 66. Once outer sleeve 30 has traveled a sufficient distance downward, gravity force causes ball bearings 22 to be urged toward receptive grooves 32, 34. Identical to the starting position, outer ball bearings 22C are positioned in the corresponding receptive grooves 32, 34 and middle ball bearings 22B and inner ball bearings 22A are also positioned nearer to the corresponding receptive grooves 32, 34. Inner ball bearings 22A and middle ball bearings 22B become positioned fully in channels 28 so as to not restrict the travel of locking member 14 when removing locking member 14 from inner sleeve 20. Once locking member 14 is removed, the first tire to be tested can be removed and an additional tire to be tested can be put in place and the previously described method can be repeated.

It should be appreciated that apparatus 10 is adapted to allow for testing different sized tires. For example, upper rim 16 includes various sized diameters, for example, smaller diameter 108 and larger diameter 110. Similarly, lower rim 18 includes various sized diameters, for example, smaller diameter 112 and larger diameter 114. Thus, smaller diameters 108, 112 can be used to engage a tire having a smaller inner circumference and larger diameters 110, 114 can be used to engage a tire having a larger inner circumference. In one or more embodiments, upper rim 16 and lower rim 18 can include more than two diameter sizes. In one or more embodiments, upper rim 16 and lower rim 18 can include two diameter sizes.

Also, as previously described, receptive grooves 78 can span the entire outer surface of locking base 66, or a majority of the entire outer surface of locking base 66. Thus, when outer sleeve 30 is in the downward, unlocked position, locking member 14 can travel such that various receptive grooves 78 therein could be aligned to eventually receive the inner ball bearings 22A. It should be appreciated that when a tire to be tested is in place between upper rim 16 and lower rim 18, the thickness, or width, of the tire will determine how far locking member 14 will travel. With a first side of the tire positioned proximate lower rim 18, locking member 14 will only be able to travel until upper rim 16 contacts, or nearly contacts, the other side of the tire. But, based on the multiple receptive grooves 78, tires of varying widths can be tested.

Apparatus 10 can further include a barcode reader (not shown) for scanning the barcode of a tire to be tested, where the barcode information could inform the apparatus 10 as to the inner circumference and thickness of the tire to be tested. Apparatus 10 can also be configured as to be automatically controlled by an associated electronic and software system. Such system would allow for the automation of one or more of the previously described method steps. Further information regarding barcodes, barcode readers, and electronic and software systems is generally known to those skilled in the art.

In view of the foregoing, it should be apparent that an apparatus for holding a tire in a tire balancing machine constructed and operated as described herein accomplishes the objects of the invention and otherwise substantially improves the art.

What is claimed is:

1. An apparatus for holding a tire in a tire balancing machine comprising a sleeve having a plurality of channels therethrough, each of said channels having a plurality of ball bearings therein, a locking member positionable in said sleeve, said locking member having an outer surface with a groove therein, said groove receiving a ball bearing from each of said channels when said locking member is positioned in said sleeve.

2. The apparatus of claim 1, further comprising a base carrying said sleeve, said base carrying one tire rim, said locking member carrying another tire rim.

3. The apparatus of claim 2, wherein a tire to be tested is positioned between said rims when said locking shaft is positioned in said sleeve, wherein said tire rim carried by said base is a stationary tire rim and said tire rim carried by said locking member is a moveable tire rim, said stationary tire rim and said moveable tire rim each including a smaller diameter and a larger diameter.

4. The apparatus of claim 1, said outer surface of said locking member having a plurality of grooves therein, one of said plurality of locking member grooves receiving a ball bearing from each of said channels having a plurality of ball bearings therein when said locking shaft is positioned in said sleeve.

5. The apparatus of claim 1, wherein said sleeve is an inner sleeve having an outer sleeve positioned therearound, said outer sleeve including a groove therein, said outer sleeve groove including a sloped inner circumferential surface.

6. The apparatus of claim 5, wherein each of said pluralities of ball bearings includes an outer ball bearing and an inner ball bearing, said outer sleeve being positionable in an unlocked position and a locked position, wherein said outer ball bearings are positioned in said groove of said outer sleeve in the unlocked position and said inner ball bearings are positioned in said groove of said locking member when in the locked position.

7. The apparatus of claim 6, wherein during the movement of said outer sleeve from said unlocked position to said locked position, said sloped inner circumferential surface urges said outer ball bearings toward said inner ball bearings to thereby position said inner ball bearings in said groove of said inner sleeve.

8. The apparatus of claim 7, each of said pluralities of ball bearings including a middle ball bearing positioned between said outer ball bearing and said inner ball bearing, such that said sloped inner circumferential surface urges said outer ball bearings into said middle ball bearings, thereby urging said middle ball bearings into said inner ball bearings.

9. The apparatus of claim 8, said outer sleeve being coupled with a guide plate, said guide plate being coupled with an air cylinder, wherein actuation of said air cylinder moves said outer sleeve from said unlocked position to said locked position.

10. The apparatus of claim 1, wherein said sleeve includes a sidewall and a bore therethrough, said channels extending angularly through said sidewall.

11. The apparatus of claim 1, wherein said sleeve includes a first row of channels and a second row of channels, said second row being longitudinally spaced from said first row.

12. The apparatus of claim 5, said outer sleeve further including a second outer sleeve groove.

13. The apparatus of claim 12, wherein each of said channels in said first row of channels and each of said channels in said second row of channels includes an outer ball bearing and an inner ball bearing.

14. The apparatus of claim 13, wherein said locking member further includes a second locking member groove, wherein each of said channels in said first row of channels and each of said channels in said second row of channels includes a middle ball bearing positioned between said outer ball bearing and said inner ball bearing.

15. The apparatus of claim 14, said outer sleeve being positionable in an unlocked position and a locked position, said outer ball bearings of said first row of channels being positioned in said first outer sleeve groove and said outer ball bearings of said second row of channels being positioned in said second outer sleeve groove in said unlocked position, and said inner ball bearings of said first row of channels being positioned in said first locking member groove and said inner ball bearings of said second row of channels being positioned in said second locking member groove in said locked position.

16. A method for securing a tire to be tested for balancing comprising the steps of
placing a first side of a tire on a first rim carried by a sleeve,
moving a locking member carrying a second rim to a position within the sleeve, and
after the second rim engages a second side of the tire, locking the locking member to the sleeve.

17. The method of claim 16, wherein the step of locking can take place at various longitudinal positions along the locking member.

18. The method of claim 16, wherein the step of locking includes transferring a ball bearing in the inner sleeve to a groove in the locking member.

19. The method of claim 18, wherein the locking member includes a plurality of grooves, where the step of transferring moves a ball bearing into a selective groove dependent on the distance from the first side of the tire to the second side of the tire.

20. The method of claim 18, wherein the step of locking occurs by an outer sleeve moving to a locked position to thereby urge a ball bearing in the inner sleeve to a groove in the locking member.
